(19) United States
(12) Patent Application Publication
(10) Pub. No.: US 2017/0168668 A1
(43) Pub. Date: Jun. 15, 2017

(54) METHOD AND ELECTRONIC DEVICE FOR DISPLAYING MENU ON APPARATUS

(71) Applicants: Le Holdings (Beijing) Co., Ltd., Beijing (CN); LE SHI INTERNET INFORMATION TECHNOLOGY CORP. BEIJING, Beijing (CN)

(72) Inventor: Beibei Sun, Beijing (CN)

(21) Appl. No.: 15/247,274

(22) Filed: Aug. 25, 2016

Related U.S. Application Data
(63) Continuation of application No. PCT/CN2016/088507, filed on Jul. 5, 2016.

(30) Foreign Application Priority Data
Dec. 11, 2015 (CN) 201510920841.9

(51) Int. Cl. G06F 3/0482; G06F 3/0488; G06F 3/0485

(52) U.S. Cl. CPC G06F 3/0482; G06F 3/04855; G06F 3/0488; G06F 2203/04803

(57) ABSTRACT

A method and an electronic device for displaying a menu on an apparatus are provided in an embodiment of the present application. Classify a tree classification to layer menus according to levels of nodes in a result of the tree classification of objects, wherein the nodes at the same level are classified into the same layer menu. Space displaying the layer menus on a display interface of the apparatus according to an object number in each of the layer menus, and modify the layer menus by a service terminal. Achieve that use the same product technical framework to display the objects of different classification and different number to reduce the cost of iterative development.

### CROSS REFERENCE TO RELATED APPLICATIONS

This application is a continuation of International Application No. PCT/CN2016/088507, filed on Jul. 5, 2016, which is based upon and claims priority to Chinese Patent Application No. 201510920841.9, filed on Dec. 11, 2015, the entire contents of which are incorporated herein by reference.

### TECHNICAL FIELD

The application relates to a video technology, for example, a method and an electronic device for displaying menu on an apparatus.

### BACKGROUND

With the rapid growth in sale of the smart apparatus such as smart television and smart phone, the expanding of over sea market, the user demands for video viewing also increased exponentially, the user demands regarding to video viewing in different countries and regions are different, and content types and number of copyright are quite different as well. How to interact with user with a good content presentation way and maximally shield the influence caused by copyright differences on TV and mobile user interface (UI) are the technical problems of the smart apparatus need to be solved as soon as possible.

The current mainstream of the solution is releasing multiple versions of the software for products sold in different countries and regions, wherein each of the multiple versions has large difference with each other. Since the mainstream of UI is a tiled display, the architecture of traditional tree structure gives the user one kind of messy feeling. At the same time, the interactions during operation are complicated and the deep layer menu gives negative user experience to the users. At the same time, when the UI is undergoing a revision, new classification and content cannot be added or deleted flexibly; if adding or deleting contents has to modify the home page or even all the interface and even re-focus, the workload is heavy, and the efficiency is low.

As a result, a general method for displaying a menu on an apparatus needs to be proposed.

### SUMMARY

A method for displaying a menu and an electronic device are provided in an embodiment of the present application so as to solve the disadvantage of cannot control the menu flexibly in the conventional technology and maximally shield the problem of the influence of the display on the apparatus caused by objects change.

An embodiment of the present application provides a method for displaying a menu on apparatus including the following steps:

Classifying a tree classification to layer menus according to levels of nodes in a result of the tree classification of objects, wherein the nodes at the same level are classified into the same layer menu.

Space displaying the layer menus on a display interface of the apparatus according to an object number in each of the layer menus, and modify the layer menus by a service terminal.

A non-transitory computer-readable storage medium storing executable instructions that, when executed by an electronic device, cause the electronic device to execute the method for displaying a menu on apparatus in any one of the embodiments of the present application.

An embodiment of the present application further provides an electronic device, including: at least one processor; and a memory communicably connected with the at least one processor, wherein the memory is stored with instructions executable by the at least one processor, and the instructions are executed by the at least one processor to cause the at least one processor to execute the method for displaying a menu on apparatus in any one of the embodiments of the present application.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart in accordance with a first embodiment of the present application;

FIG. 2a is a schematic view of a tree classification in accordance with some embodiments of the present application;

FIG. 2b is a schematic view of a classification of a layer menu in accordance with some embodiments of the present application;

FIG. 3 is a schematic view of a display page switching in accordance with some embodiments of the present application;

FIG. 4 is a schematic view of a horizontal expansion of the layer menu in accordance with some embodiments of the present application;

FIG. 5a is a schematic view of an upper half region of a vertical expansion of the layer menu in accordance with some embodiments of the present application;

FIG. 5b is a schematic view of a bottom half region of a vertical expansion of the layer menu in accordance with some embodiments of the present application;

FIG. 6 is a schematic view of an apparatus structure in accordance with a second embodiment of the present application; and

FIG. 7 is a schematic view of a hardware structure of an electronic device in accordance with a fourth embodiment of the present application.

### DETAILED DESCRIPTION

To make the objectives, technical solutions, and advantages of the embodiments of the present disclosure more comprehensible, the following clearly describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

To make the objectives, technical solutions, and advantages of the embodiments of the present disclosure more comprehensible, the following combines the figures and specific embodiments, to further describe the present application in detail.

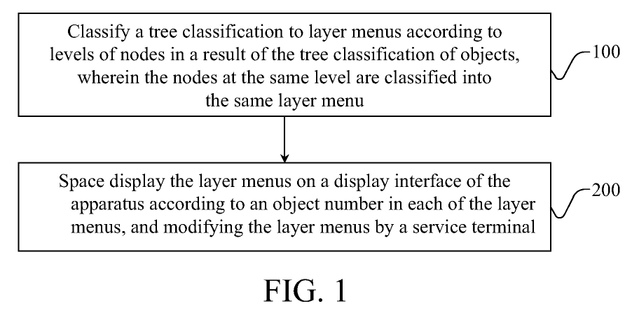

FIG. 1 is a flow chart in accordance with a first embodiment of the present application. In combination with FIG. 1, the first embodiment of the present application is a method for displaying a menu on an apparatus, which includes two main steps:

In Step 100: classifying a tree classification to layer menus according to levels of nodes in a result of the tree classification of objects, wherein the nodes at the same level are classified into the same layer menu.

The tree classification is a data classification according to the “one to many” of the tree shape relationships among the data elements. In the tree classification structure, a root node has no superior, and each of other nodes has only one superior, a number of the child nod of each of the nodes can be one or multiple, wherein a leaf node has no child node. In a figure of the tree classification, a number of the branches of the route from the root node to a node in the tree is the layer of the node. The layer of the root node is defined as 1, and the layer of the other nodes is equal to the layer of their parent nodes plus 1.

In the embodiment of the present application, takes programs waiting to be broadcasted as objects waiting to be displayed to explain the embodiment of the present application.

Use the tree classification method to classify the programs waiting to be broadcasted according to the number and the type, and get a result of the tree classification of the programs, wherein a sub-classification is corresponding to one of the nodes of the tree classification. According to the specific tree classification, classify multiple parallel first classifications as first layer menu and the following second classification as corresponding second layer menu, and so on if there is multilayer menus.

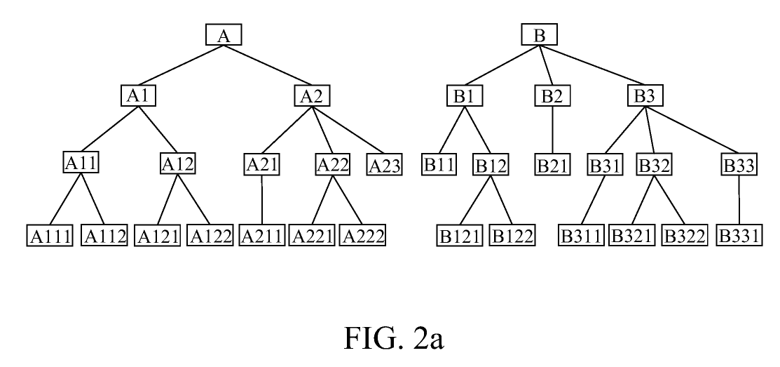

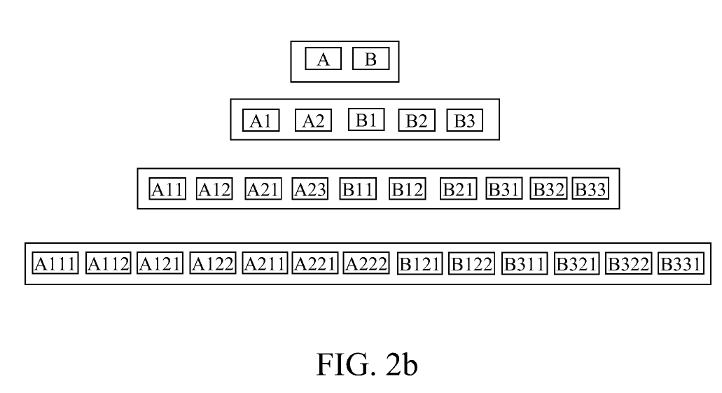

Suppose programs waiting to be broadcasted now are A and B two types, classify the programs belonging to A type and B type as the tree classification figure in FIG. 2a according to the parent and child layer relationship. Wherein, the node layer of A and B is 1, the node layer of A1, A2, B1, B2 and B3 is 2, the node layer of A11, A12, A21, A22, A23, B11, B12, B21, B31, B32 and B33 is 3, and the node layer of A111, A112, A121, A122, A211, A222, B121, B122, B311, B321, B322 and B331 is 4. Classify the programs with the node at the same level to the same layer to obtain a layer shown in FIG. 2b. The above data is only for illustration but not the limitation to the embodiment of the present application.

In Step 200: space displaying the layer menus on a display interface of the apparatus according to an object number in each of the layer menus, and modifying the layer menus by a service terminal.

This step mainly includes three parts, wherein displaying each of the objects included in each of the layer menus further includes following step 211 to step 212.

In Step 211: dividing the display interface into M areas which respectively display a N^{th} layer menu to a (N+M)^{th} layer menu.

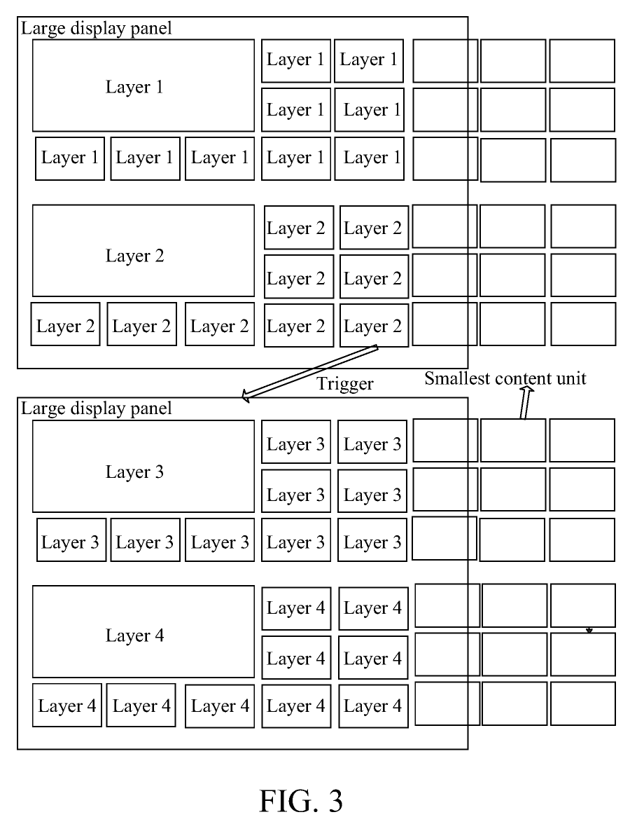

In the embodiment of the present application, when displaying the layer menu, taking into account of user's visual experience and the richness of the program information, a display panel is usually divided into M different regions and displays different layer menus in different regions, respectively. One layer menu or more than two layer menus can be displayed in the same page on the panel, a display style of each layer menu can be any combination of the smallest content unit, wherein the smallest content unit can be the smallest constituent unit in the layer menu which is the displaying style of a single sub-classification included in each layer. It is shown in FIG. 3.

In this step, a value of M can be modified according to a size of the panel of the apparatus, and the beauty and being elegant of the interface need to be taken into account. Generally, M=2 is a reasonable value, the display panel is divided into two regions, which is the upper and the bottom parts, each part displays a layer menu to give the user a better user experience. For example, the upper part of the first page can display the first layer menu, and the bottom part can display the second layer menu, as shown in FIG. 3.

In Step 212: Triggering the (N+M)^{th} layer menu, and enter a new display interface.

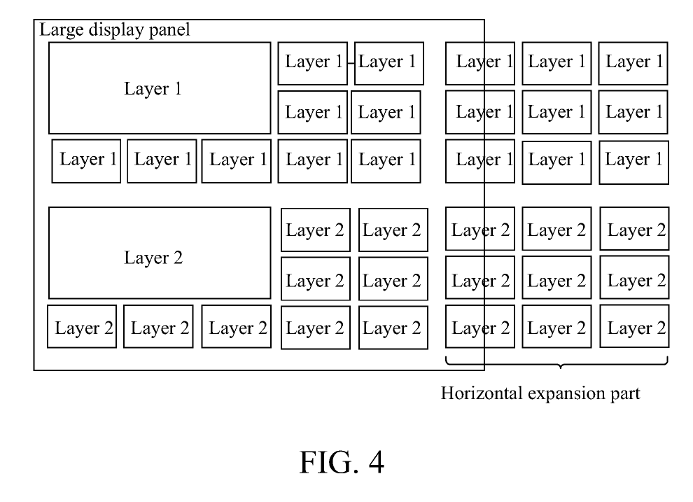

The layer menus displayed in each displaying page are in layers with different height; for example, as shown in FIG. 3, the higher layer is the first layer menu, and the lower layer is the second layer menu. In this embodiment of the present application, if there are multiple layer menus, you can trigger the lowest layer menu in the present display page and then enter the next display page, wherein the next display page displays the next layer menu of the lowest layer menu, and the layer number can be the same as the previous display page or be modified according to the remaining layer number to be displayed. As shown in FIG. 4, trigger the second layer menu then enter the next display page; similarly, the next display page uses the upper part and the bottom part to display the content of the third layer menu and the fourth layer menu, trigger the fourth layer menu and enter the new display page will display the fifth page and the sixth page, and so on until completely displayed.

In the step 211 to step 212, by using the uniform structure, perform the complicated tree structure in the multilayer way, which is convenient to flexibility adjust the display interface according to the different program number and program content while optimizing the user experience.

In this embodiment of the present application, space displaying the layer menus on a display interface of the apparatus according to an object number in each of the layer menus specifically includes processes of following step 221 to step 223.

In Step 221: When the program number in the same layer menu being too much to be completely displayed is detected, the smallest content units in the setting displaying style are assembled in any combination to be the expansion part.

If there is too many content belong in the same layer menu to be completely displayed, expand the accommodation space of the layer to display more programs to be watched by the user. Wherein, the expansion space in the original display interface is not complete, and only a part is displayed to remind the user to check the expansion content. The user, according to the requirement, can completely display the expand part by sliding the display interface or pulling a scroll bar. In this embodiment, according to the apparatus type difference, there are different corresponding expansion way. For the apparatus with larger display panel, the method in step 222 is taken to display the content of the expansion part. For the apparatus with smaller display panel, the method in step 223 is taken to display the content of the expansion part.

In Step 222: When a horizontal slide of the display interface or a horizontal scroll bar being pulled is detected, display a content of the menu corresponding to a part of the horizontal expansion

FIG. 3 shows the horizontal expansion of the layer space, and this expansion way mainly focus on the apparatus with larger display panel, such as television, desktop computer monitor, etc. In the original display panel not being slide or pulled, the expansion part is not completely displayed, which can use the space of the display panel rationally and prompt the user.

In Step 223: When a vertical slide of the display interface or a vertical scroll bar being pulled is detected, display a content of the menu corresponding to a part of the vertical expansion.

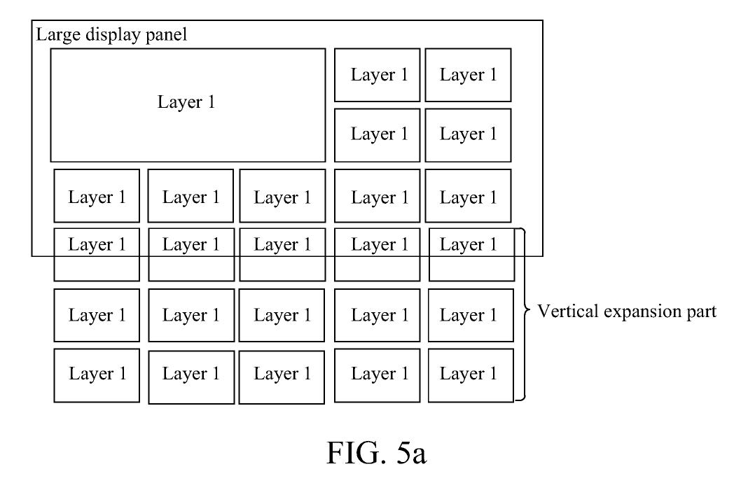

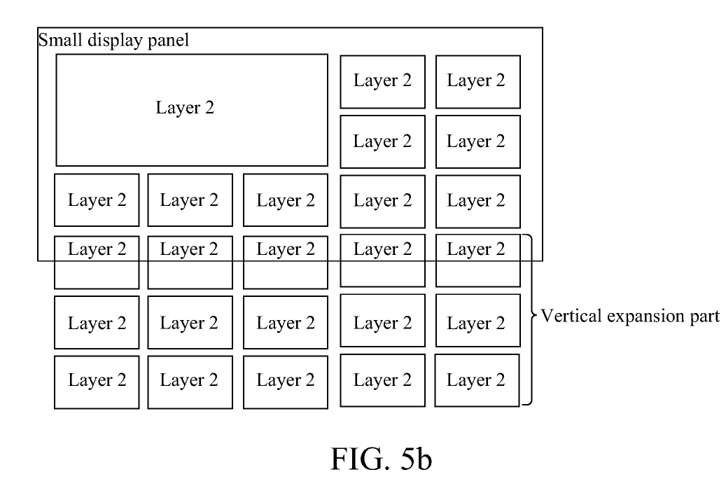

FIGS. 5a and 5b are schematic views vertical expansion of the layer space, and the vertical expansion is usually used in the apparatus with smaller panel, such as cell phone.

Of course, an embodiment of the present application also includes a situation that for an apparatus with smaller panel, when the panel being at a horizontal state is detected, the method of the horizontal expansion can also be taken to increase the layer space so as to give the user better experience.

In Step 221 to 223 which use the horizontal and the vertical space extension make the content displayed can well adopt to the apparatus with different panel size. At the same time, when the content and the number of the program are increased, new classification and content can be directly added in a flexible and efficient way.

In this embodiment of the present application, modify the layer menus by a service terminal, which is mainly focus on a defect of the conventional method that only fixedly write the layer depth, content of the program, program number and display style which are displayed into the client terminal of the apparatus.

In this embodiment of the present application, store each of the display information of the layer menu in the service terminal, and thus the service terminal control each of the display information of the layer menu, wherein the display information includes the depth of the layer menu, the object number of the layer menu, the object content of the layer menu, the displaying style of the page where the layer menu located and the displaying rule of a next layer of the layer menus corresponding to the layer menu.

Wherein, the depth of the layer menu is equal to the maximum layer number of the node in the tree classification figure; for example, in FIGS. 2a and 2b, the depth of the layer menu is 4. The value of the depth of the layer menu is determined by the maximum number of the sub-classification, which is the level of detail of the classification of the authorized broadcast programs. If the content of the program is changed, while displaying the playable programs to the user, real-time accesses the data in the service terminal to adjust the display interface. When the classifications of the programs are increased, which means the leaf node at the terminal branch of the original tree classification becomes the parent node, while correspondingly transforms to the layer menu, the depth of the layer menu is correspondingly increased; in contrast, when the classification is decreased, the depth of the layer menu is decreased so as to achieve the directly control to the display depth of the layer menu through the service terminal.

The program number of the layer menu and the program content of the layer menu are adjusted according to the program content having the copyright in different country. The display style of the page that the layer menu located, which means the layer menu is displayed by what kind of combination of the smallest content units, such as arranging the smallest content units in size order or focus on highlighting an unit, etc.

By the service terminal, the depth of the layer, the name, the number and the displaying style, etc. are flexibly arranged; even though the display apparatus is operated in different regions, the programs with different copyright being faced can be flexibly displayed, reduce the cost of iterative development, and maximally shield the influence caused by the copyright difference

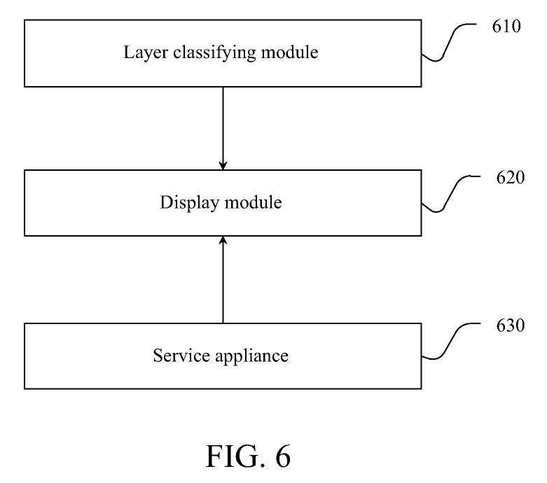

FIG. 6 is a schematic view of an apparatus structure in accordance with a second embodiment of the present application. In combination with FIG. 6, the embodiment of the present application is an electronic device for displaying a menu on an apparatus, which includes the following modules: a layer classifying module 610, a display module 620 and a service appliance 630.

The layer classifying module 610 for classifying a tree classification to layer menus according to levels of nodes based on a result of the tree classification of objects, wherein the nodes at the same level are classified into the same layer menu.

The display module 620 connected with the layer classifying module 610 and the service appliance 630 is for space displaying the layer menus on a display interface of the apparatus on the basis of an object number in each of the layer menus.

The service appliance 630 is for modifying the layer menus.

Further, the display module 620 is specifically configured for: dividing the display interface into M areas which respectively display a N^{th} layer menu to a (N+M)^{th} layer menu; triggering the (N+M) th layer menu and enter a new display interface; repeat the step of dividing the display interface into M areas which respectively display a N^{th} layer menu to a (N+M)^{th} layer menu and the step of triggering the (N+M)^{th} layer menu and enter a new display interface until all layer menus are completely displayed.

Further, the display module 620 is specifically configured for: perform a space extension to the layer menu on the display interface of the apparatus for accommodating more the objects according to an object number in each layer menu, wherein the space extension comprises a horizontal expansion and a vertical expansion.

Further, the display module 620 is configured for: when a situation of a horizontal slide of the display interface or a horizontal scroll bar being pulled is detected, display a content of the menu corresponding to a part of the horizontal expansion; and/or, when a situation of a vertical slide of the display interface or a vertical scroll bar being pulled is detected, display a content of the menu corresponding to a part of the horizontal expansion.

Further, the service appliance is specifically configured for: storing display information of each of the layer menus in the service appliance to make the service appliance control the display information of each of the layer menus, wherein the display information comprises a depth of the layer menu, an object number of the layer menu, an object content of the layer menu, a displaying style of the page where the layer menu located and a displaying rule of a next layer of the layer menus corresponding to the layer menu, etc.

The apparatus showed in FIG. 6 can execute the method of the embodiment shown in FIG. 1, and the principle and technical effects are refer to the embodiment in FIG. 1, which will not repeat hereafter.

The apparatus described above embodiments are merely illustrative, wherein the unit as a separate member described may or may not be physically separate, as part of the display unit may or may not be physical units, i.e., it may be located in one place, or may be distributed to multiple network elements. You can select some or all of the modules to achieve the purpose of the present example of embodiment according to the actual program needs. Those of ordinary skill in the case without paying any creative work that can be understood and implemented.

An embodiment of the present application provides a non-transitory computer-readable storage medium. The non-transitory computer-readable storage medium stores executable instructions that, when executed by an electronic device, cause the electronic device to execute the method for displaying a menu on apparatus in any one of the method embodiments.

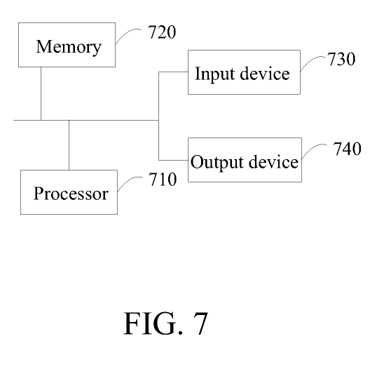

FIG. 7 is a schematic view of a hardware structure of an electronic device in accordance with a fourth embodiment of the present application. As shown in FIG. 7, the electronic device includes: one or multiple processor(s) 720 and a memory 710. The number of the processor 720 is one in FIG. 7 as an example.

The electronic device for executing the method for displaying a menu on an apparatus can further includes: an input device 730 and an output device 740.

The processor 720, the memory 710, the input device and the output device can be connected to each other via a bus or other members for electrical connection. In FIG. 7, they are connected to each other via the bus in this embodiment.

The memory 710 is one kind of non-transitory computer-readable storage mediums applicable to store non-volatile s non-transitory programs, non-transitory computer-readable programs and modules; for example, the program instructions and the function modules corresponding to the method for displaying a menu on an apparatus in the embodiments. The processor 720 executes function applications and data processing of the server by running the non-transitory software programs, non-transitory computer-readable programs and modules stored in the memory 710, and thereby the method for displaying a menu on the apparatus in the aforementioned embodiments are achievable.

The memory 710 can include a program storage area and a data storage area, wherein the program storage area can store an operating system and at least one application program required by a function; the data storage area can store the data created according to the usage of the electronic device for displaying a menu on the apparatus. Furthermore, the memory 710 can include a high speed random-access memory, and further include a non-transitory solid state memory such as at least one disk storage member, at least one flash memory member and other non-transitory solid state storage member. In some embodiments, the memory 710 can have a remote connection with the processor 720, and such remote memory can be connected to the electronic device for displaying a menu on the apparatus by a network. The aforementioned network includes, but not limited to, internet, intranet, local area network, mobile communication network and combination thereof.

The input device can receive digital or character information, and generate a key signal input corresponding to the user setting and the function control of the electronic device for displaying a menu on the apparatus. The output device can include a displaying unit such as screen.

The one or more modules are stored in the memory 710. When the one or more modules are executed by one or more processor 720, the method for displaying a menu on the apparatus disclosed in any one of the embodiments is performed.

The aforementioned product can execute the method provided in the embodiment of the present application, having the function modules and beneficial effects corresponding to execute the method. The technical details which are not clearly described in this embodiment can be referred to the method provided in the embodiments of the present application.

The electronic device in the embodiments of the present application is presence in many forms, and the electronic device includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatuses: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic device having a data exchange function.

The above-described apparatus embodiments are merely illustrative, wherein units described as separate parts may or may not be physically separated, part as display unit may or may not be a physical unit, which may be located in one place, or can be distributed to multiple network elements. You can select some or all of the modules to achieve the purpose of the present embodiment according to the actual requirements.

Through the above description of the implementation manners, a person skilled in the art can clearly understand that, the aspects of the present disclosure may be achieved in a manner of combining software and a necessary common hardware platform, and certainly may also be achieved by hardware. Based on such understanding, the technical solutions of the aspects of the present disclosure can be reflected in a form of a software product. The computer software product is stored in a computer readable storage medium such as ROM/RAM, hard disk, CD, etc., includes several instructions to make a computer device (which may be a personal computer, a server, a network device, or the like) execute the method described in the embodiments or a part of the embodiments.

While we have shown and described the embodiment in accordance with the present invention,

Finally, it should be noted that: the above embodiments are merely to illustrate the technical solutions of the present application, but not intended to limit; although the present application has been described in detail refer to the above embodiments, it should be clear to those skilled in the art that the technical solutions in the above embodiments can be amended, or a part of the technical features can be equivalently replaced; these amendments and replacements will not make the spirit of the corresponding technical solution departing from the spirit and the scope of the present invention.

What is claimed is:

1. A method for displaying a menu on apparatus, applied on a terminal, comprising:
classifying a tree classification to layer menus according to levels of nodes in a result of the tree classification of objects, wherein the nodes at the same level are classified into the same layer menu;
space displaying the layer menus on a display interface of the apparatus according to an object number in each of the layer menus, and modifying the layer menus by a service terminal.

2. The method according to claim 1, wherein the step of displaying the layer menus on a display interface of the apparatus according to the object number in each of the layer menus comprises:
dividing the display interface into M areas which respectively display a N^{th} layer menu to a (N+M)^{th} layer menu;
triggering the (N+M)^{th} layer menu and entering a new display interface; and
repeating the step of dividing the display interface into M areas which respectively display the N^{th} layer menu to the (N+M)^{th} layer menu and the step of triggering the (_{N+M)}^{th} layer menu and entering the new display interface until all layer menus are completely displayed.

3. The method according to claim 2, the method further comprising:
performing a space extension to the layer menu on the display interface of the apparatus for accommodating more the objects according to an object number in each layer menu, wherein the space extension comprises a horizontal expansion and a vertical expansion.

4. The method according to claim 3, the method further comprising:
when a situation of a horizontal slide of the display interface or a horizontal scroll bar being pulled is detected, displaying a content of the menu corresponding to a part of the horizontal expansion; and/or
when a situation of a vertical slide of the display interface or a vertical scroll bar being pulled is detected, displaying a content of the menu corresponding to a part of the horizontal expansion.

5. The method according to claim 1, wherein the step of modifying the layer menus by the service terminal comprises:
storing display information of each of the layer menus in the service terminal so as to control the display information of each of the layer menus by the service terminal, wherein the display information comprises a depth of the layer menus, an object number of the layer menus, an object content of the layer menus, a displaying style of the page where the layer menus located and a displaying rule of a next layer of the layer menus corresponding to the layer menus.

6. The method according to claim 1, before the step of classifying the tree classification to the layer menus according to the levels of the nodes in the result of the tree classification of objects, further comprising:
taking the tree classification to classify the objects waiting for display according to number and type of the objects, and obtaining the result of the tree classification of the objects, wherein a sub-classification of one object is corresponding to one of the nodes of the tree classification.

7. A non-transitory computer-readable storage medium storing executable instructions that, when executed by an electronic device, cause the electronic device to:
classify a tree classification to layer menus according to levels of nodes in a result of the tree classification of objects, wherein the nodes at the same level are classified into the same layer menu;
space display the layer menus on a display interface of an apparatus according to an object number in each of the layer menus, and modifying the layer menus by a service terminal.

8. An electronic device, comprising:
at least one processor; and
a memory communicably connected to the at least one processor; wherein,
the memory is stored with instructions executable by the at least one processor, and the instructions are executed by the at least one processor to cause the at least one processor to:
classify a tree classification to layer menus according to levels of nodes in a result of the tree classification of objects, wherein the nodes at the same level are classified into the same layer menu;
space display the layer menus on a display interface of an apparatus according to an object number in each of the layer menus, and modifying the layer menus by a service terminal.

9. The non-transitory computer-readable storage medium according to claim 7, wherein the space displaying the layer menus on a display interface of the apparatus according to the object number in each of the layer menus comprises:
dividing the display interface into M areas which respectively display a N^{th} layer menu to a (N+M)^{th} layer menu;
triggering the (_{N+M)}^{th} layer menu and entering a new display interface; and
repeating the step of dividing the display interface into M areas which respectively display the N^{th} layer menu to the (N+M)^{th} layer menu and the step of triggering the (N+M)^{th} layer menu and entering the new display interface until all layer menus are completely displayed.

10. The non-transitory computer-readable storage medium according to claim 9, wherein the electronic device is further caused to:
perform a space extension to the layer menu on the display interface of the apparatus for accommodating more of the objects according to an object number in each layer menu, wherein the space extension comprises a horizontal expansion and a vertical expansion.

11. The non-transitory computer-readable storage medium according to claim 10, the electronic device is further caused to:
when a situation of a horizontal slide of the display interface or a horizontal scroll bar being pulled is detected, display a content of the menu corresponding to a part of the horizontal expansion; and/or
when a situation of a vertical slide of the display interface or a vertical scroll bar being pulled is detected, display a content of the menu corresponding to a part of the vertical expansion.

12. The non-transitory computer-readable storage medium according to claim 7, wherein the modifying the layer menus by the service terminal comprises:
storing display information of each of the layer menus in the service terminal so as to control the display information of each of the layer menus by the service terminal, wherein the display information comprises a depth of the layer menus, an object number of the layer menus, an object content of the layer menus, a displaying style of a page where the layer menu located and a displaying rule of a next layer of the layer menus corresponding to the layer menus.

13. The non-transitory computer-readable storage medium according to claim 7, before classifying the tree classification to layer menus according to levels of nodes in a result of the tree classification of objects, the electronic device is further caused to :
take the tree classification to classify the objects waiting for display according to number and type of the objects, and obtain the result of the tree classification of the objects, wherein a sub-classification of one object is corresponding to one of the nodes of the tree classification.

14. The electronic device according to claim 8, wherein the space displaying the layer menus on a display interface of an apparatus according to the object number in each of the layer menus comprises:
dividing the display interface into M areas which respectively display a N^{th} layer menu to a (N+M)^{th} layer menu;
triggering the (N+M)^{th} layer menu and entering a new display interface; and
repeating the step of dividing the display interface into M areas which respectively display the N^{th} layer menu to the (N+M)^{th} layer menu and the step of triggering the (N+M)^{th} layer menu and entering the new display interface until all layer menus are completely displayed.

15. The electronic device according to claim 14, the at least one processor is further caused to:
perform a space extension to the layer menu on the display interface of the apparatus for accommodating more of the objects according to an object number in each layer menu, wherein the space extension comprises a horizontal expansion and a vertical expansion.

16. The electronic device according to claim 15, the at least one processor is further caused to:
when a situation of a horizontal slide of the display interface or a horizontal scroll bar being pulled is detected, display a content of the menu corresponding to a part of the horizontal expansion; and/or
when a situation of a vertical slide of the display interface or a vertical scroll bar being pulled is detected, display a content of the menu corresponding to a part of the vertical expansion.

17. The electronic device according to claim 8, the at least one processor is further caused to:
store display information of each of the layer menus in the service terminal so as to control the display information of each of the layer menus by the service terminal, wherein the display information comprises a depth of the layer menus, an object number of the layer menus, an object content of the layer menus, a displaying style of the page where the layer menus located and a displaying rule of a next layer of the layer menus corresponding to the layer menus.

18. The electronic device according to claim 7, before classifying the tree classification to the layer menus according to the levels of the nodes in a result of the tree classification of the objects, the at least one processor is further caused to:
take the tree classification to classify the objects waiting for display according to number and type of the objects, and obtain the result of the tree classification of the objects, wherein a sub-classification of one object is corresponding to one of the nodes of the tree classification.
